(19) United States
(12) Patent Application Publication
(10) Pub. No.: US 2018/0260190 A1
(43) Pub. Date: Sep. 13, 2018

(54) SPLIT AND MERGE GRAPHS

(71) Applicant: Microsoft Technology Licensing, LLC, Redmond, WA (US)

(72) Inventor: Congyong Su, Sammamish, WA (US)

(73) Assignee: Microsoft Technology Licensing, LLC, Redmond, WA (US)

(21) Appl. No.: 15/455,942

(22) Filed: Mar. 10, 2017

(51) Int. Cl. G06F 7/32; G06T 11/60; G06T 11/20; G06F 17/30

(52) U.S. Cl. CPC G06F 7/32; G06T 11/60; G06F 17/30324; G06F 17/30424; G06T 11/206

(57) ABSTRACT

In non-limiting examples of the present disclosure, systems, methods and devices for merging a plurality of subsets split from a first graphically represented data set are provided. A query specifying one or more relationships between a node in a first subset of the plurality of subsets and a node in a second subset of the plurality of subsets may be received. One or more outgoing edges to the second subset corresponding to at least one of the one or more relationships common to the node in the first subset and the node in the second subset may be identified. The first subset and the second subset may be merged, and feedback related to the node in the second subset corresponding to the query may be provided. According other examples, a lazy merge may be implemented in querying disjoined subsets and subsequently merging those subsets.

### BACKGROUND

Traditional databases provide schema-specific storage mechanisms, which generally categorize specific data types into searchable indexes based on the schema that a specific database implements. Alternatively, databases that provide data-first indexing of resources, and graphs that represent the indexed information, may quickly become unwieldy because of the lack of requirement that the resources being input into such databases meet a specific schema accepted by the database and the storage requirements associated with indexing resources in such a manner.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Non-limiting examples of the present disclosure describe systems, methods and devices for splitting data sets into subsets and merging those subsets, or portions thereof, in response to received queries. According to examples, a data set may be stored in tuple form and relationships amongst related resources may be graphically represented in tree and node form. A determination may be made, based one or more factors, that a data set should be split into one or more subsets. For example, the storage constraints of a storage array may make splitting a data set for storage on one or more secondary storage arrays desirable or necessary.

Upon splitting a data set, a query specifying one or more relationships between a node in a first subset and a node in a second subset may be received and an outgoing edge to the second subset corresponding to at least one of the one or more relationships common to the node in the first subset and the node in the second subset may be identified. In this manner the first and second subset may be merged and feedback related to the query may be provided.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 illustrates an overview of an example system for splitting Sets and merging sub sets.

FIG. 2 illustrates an exemplary environment for Set creation from multiple entities having multiple resources.

FIG. 3A illustrates an example isolated collection of asserted resource identifiers and corresponding relationships.

FIGS. 3B-3E illustrate an example query model that may be used to traverse a collection of nodes within a Set.

FIG. 4 illustrates an exemplary distributed computing environment for splitting and merging Sets.

FIG. 5 illustrates three exemplary nodes of a Set and their corresponding tuple information prior the Set being split.

FIG. 6A illustrates the relationships that three exemplary nodes of a Set have amongst one another prior to the Set being split.

FIG. 6B illustrates the relationships that the three exemplary nodes of FIG. 6A have after splitting their corresponding Set at the tuple level of one of the nodes.

FIG. 7 is an exemplary method for splitting and merging a Set.

FIG. 8 illustrates a computing device for executing one more aspects of the present disclosure.

FIG. 9 is a simplified block diagram of a computing device with which aspects of the present disclosure may be practiced.

FIG. 10 is a block diagram illustrating physical components (e.g., hardware) of a computing device 1000 with which aspects of the present disclosure may be practiced.

FIG. 11 is a schematic diagram illustrating an example distributed computing environment for splitting and merging graphical data sets.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure provides systems, methods, and devices for splitting and merging a graphical representation of a data set represented by tuples. A data-first database generated through the analysis and indexing of a plurality of resources (e.g., documents, websites, audio files, images, video files, etc.) may be created to graphically represent the resources and relationships amongst those resources through node creation, property analysis, attribute assignment, and tuple element designation.

According to examples, resources input into such a system may be contextually analyzed and determinations may be made regarding the resources' properties, such as associated party properties, locational properties, temporal properties, topical properties, and/or associated task properties, among others. Each resource, or portions of each resource (e.g., pages of a website, portions of a document, etc.), may be represented in the database as one or more node in a tree-like structure, and the determined properties of those resources may be associated with those nodes as node attributes.

Certain information corresponding to each node of a data set may be associated with the node as a tuple. For example, one element of a tuple for a node may provide a node identifier, such as a number (e.g., Node ID: 1, Node ID: 2, Node ID: X, etc.). Another element of a tuple for a node may represent relationships that the node has to other nodes in the data set. The relationships may relate to the attributes that nodes in the dataset have in common such as associated party attributes, locational attributes, temporal attributes, topical attributes, and associated task attributes, among others. A third element of a tuple for a node may be an object associated with the node, which may provide a value for an attribute or a designation that points to another node in the database. For example, if the second element in the tuple associates a temporal or “date” attribute with a node, a value may be provided for that attribute as it relates to a property of the resource. Alternatively, if the third element in the tuple provides a designation that references or is related to another node in the database, that designation may denote a value for the property in the second element of the tuple which may be located by referencing the value of the other node in the database (e.g., “valNodeID”). In another example, the third element may simply reference a node identifier of another node in the database.

According to a specific example, if a resource input into the database has been identified as having a date associated with it, the second element of the tuple may be a “date” attribute, and if there is a specific date associated with that resource, that value (e.g., February; February 17; February 17, 2017; etc.) may comprise the value of the third element of the tuple. Similarly, rather than providing a value for an attribute represented as an element of a tuple for a node, a third (or fourth, or fifth, etc.) element of the tuple may point to a related node in the data set by referencing the related node's node identifier. Thus one or more atomic data pieces (e.g., the most basic and smallest pieces of information that can be determined from resources) from a resource may be classified as tuple elements which can be associated with nodes in a database and utilized in determining and creating relationships amongst nodes in the database and obtaining relevant information related to queries that may impact one or more of those nodes of a graph representing a data set in a database.

In some instances it may be desirable or necessary to split a data set into a plurality of subsets which may be stored on one or more storage arrays. As described herein, a storage array describes one or more storage devices, which may be located amongst one or more local or distributed computing environments. According to an example, a first data set may be stored on a first storage array that has limited storage capabilities, and thus, when the data set meets or exceeds a data storage threshold relative to that storage array, it may be desirable or necessary to split the data set such that one or more split subset of the data set is stored on one or more secondary storage arrays.

Determinations regarding whether to split a data set into subsets for storage on one or more secondary storage arrays may be made based on automated, machine-implemented, calculations regarding storage thresholds, or user commands (e.g., a database administrator may determine that one or more data set should be split for storage on or more secondary storage arrays). For example, a threshold may be implemented that specifies, based on: the current size of a data set, the growth rate of a data set, the amount of storage left on a storage device hosting a data set, the amount of storage available for a specific data set or type of data set, etc., that a data set should be split once a certain threshold has been met or exceeded as it relates to such factors. The command to split such a data set may be made by a database administrator or an automated mechanism based on the threshold being met or exceeded. Similarly, the determination of where to split a data set (e.g., how much of a data set will be split and stored on one or more secondary storage arrays, whether to split a data set at a node boundary or a tuple level boundary for a node, etc.) may be made based on storage devices that are determined to be available for storage and/or the storage and performance capabilities of those arrays.

According to some examples, it may be desirable to merge one or more split data sets into a larger collection. For example, a query referencing related nodes in two or more subsets may be received and in order to obtain the relevant information related to that query it may be necessary to merge the subsets containing the related nodes. Multiple subsets may be merged into one collection by lazily evaluating tuple information related to a query. That is, a subset may only be called for information related to a query when it is needed and a value may only be provided as feedback to a query during a merge of relevant subsets when a tuple containing that information has been identified.

Multiple subsets can be merged into a single set by iteratively applying a merge for those subsets. Such a merge may be made upon receiving a query that references information in two or more subsets. Exemplary data set queries that may result in the merging of subsets include the following:

string[_] GetRelationships(id, anchor);

string[_] GetRelated(id, rel, anchor);

KVP[ ] GetProperties(id); and

bool Contains(id).

In the above exemplary query types, “[ ]” denotes a subset with a stable order. The stable order is ensured with a comparer. “[ ]” denotes an unordered collection. For example, “anchor” is an optional parameter that is used to set a named starting point. “GetRelationships” and “GetRelated” provide a mechanism for retrieving a node's outgoing immediate relationships and that retrieval is performed through lazy evaluation. To list tuple IDs in a graph, the string “GetRelated(graphName|ID, ‘member’)” may be input.

A “MergeGraph” operation may implement a “QueryGraph” operation and have two inner query graphs. For the “GetRelated” operation, a merge of the “First.GetRelated” operation and the “Second.GetRelated” will result, while preserving the order. The comparer in this scenario is also the comparer to determine the stable order of the returned collection. Thus, in a query such as “GetRelated (id, rel abc)” will return node IDs for each node in each subset that contains relationship “rel abc” in its corresponding tuple, while maintaining the order of the original data set from which the subsets were split. According to additional examples, if a “GetProperties” query is received that returns conflicting values for a single property, metadata or a schema associated with the data set/graph may be used to determine a merge policy for those values (e.g., concatenation, union, overwrite).

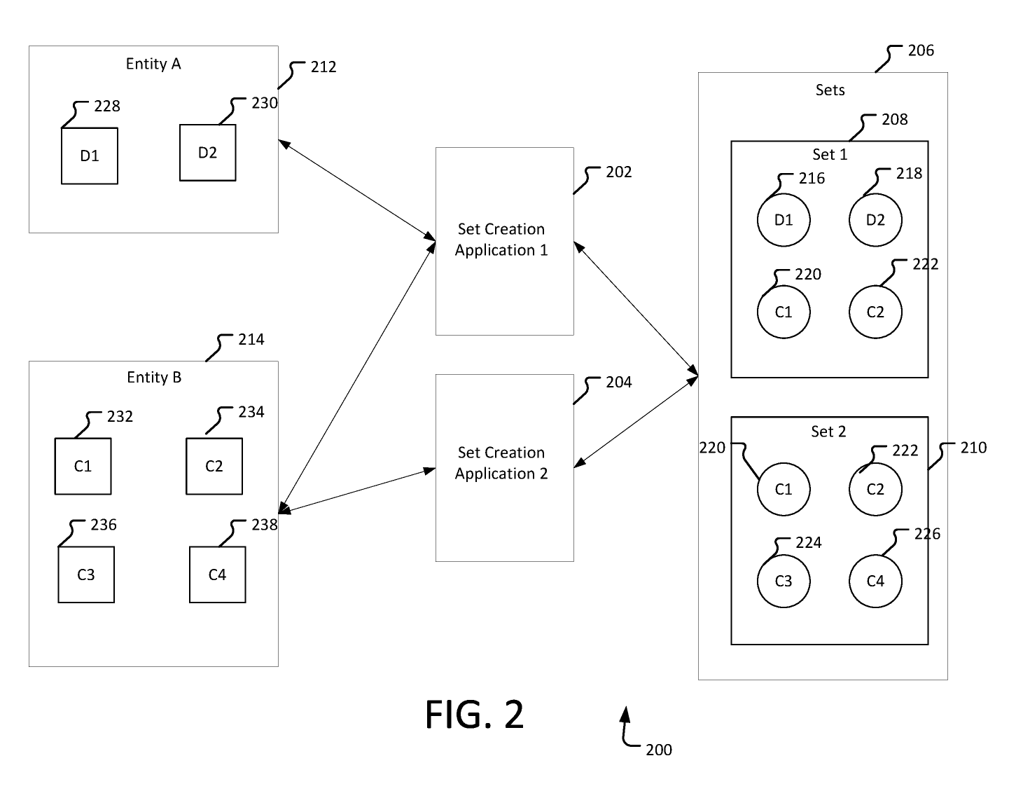

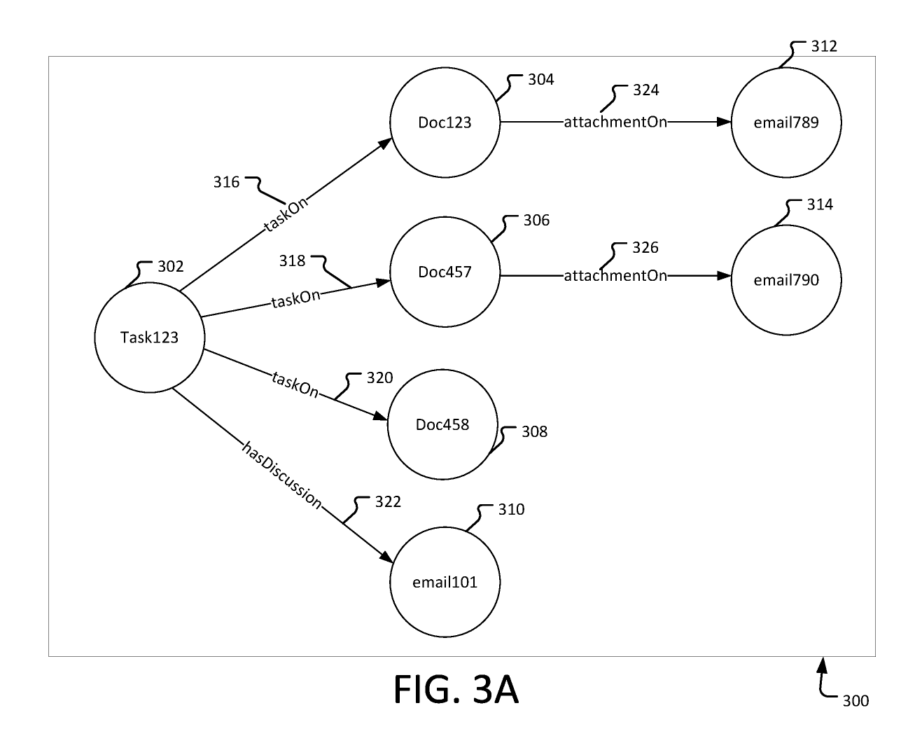

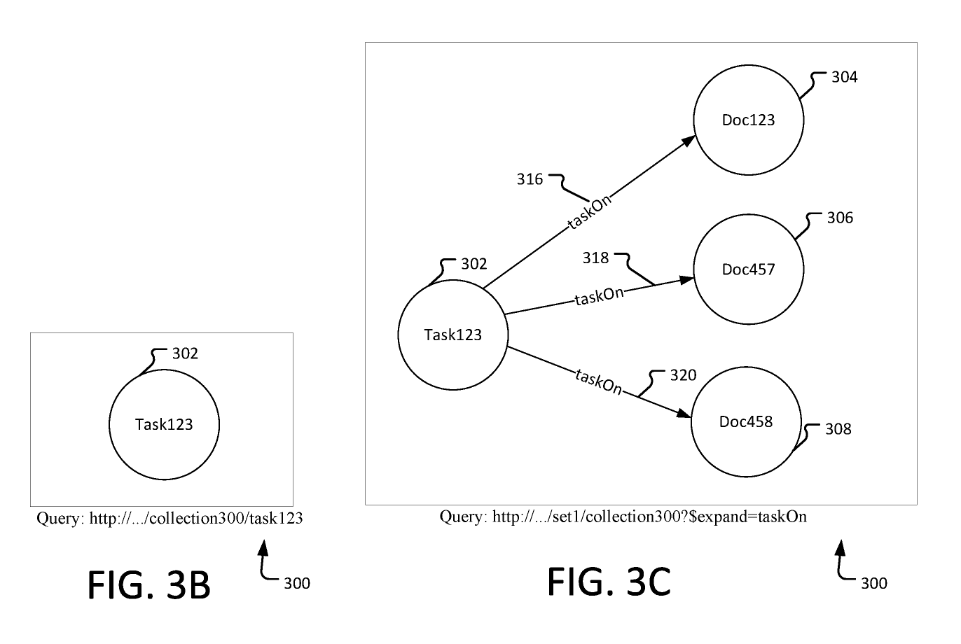

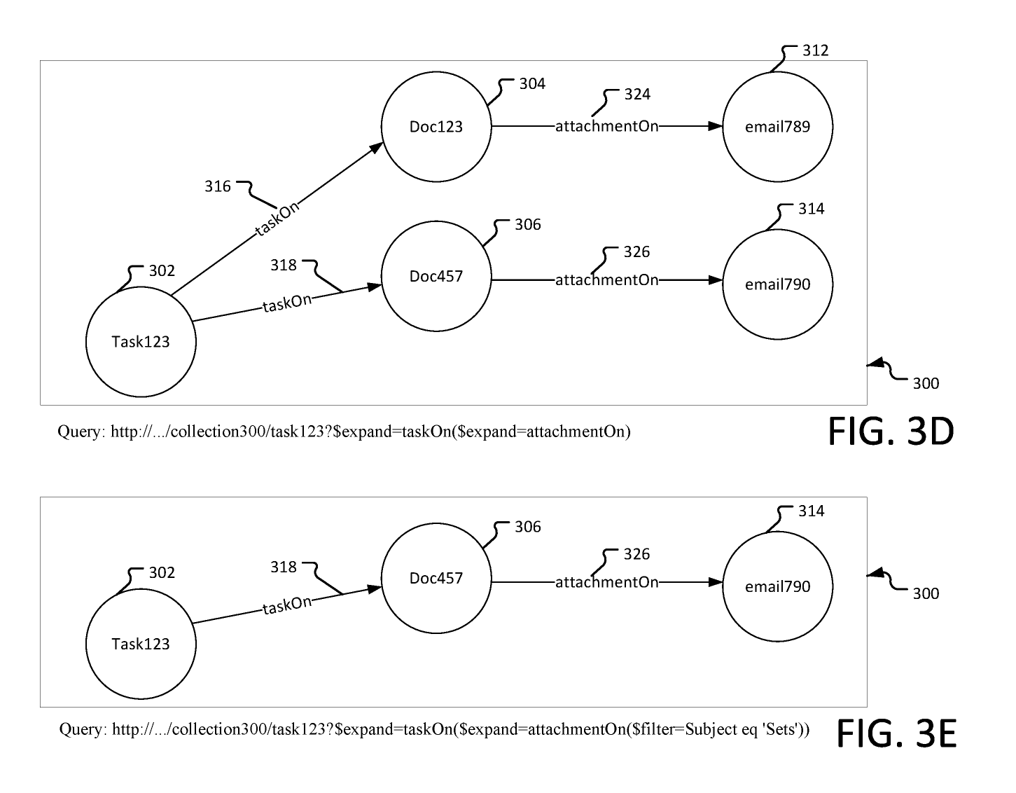

Various different data structures may be employed to represent the relationships amongst nodes, node attributes, and resources and resource properties. For example, a linked list or a relational database may be used to store information about nodes and resources. Alternatively, a graph, also referred to herein as a Set or isolated collection, may be used to represent various nodes and resources and their corresponding attributes and properties. Additional information regarding the creation and use of a Set will be provided below with respect to FIGS. 2 and 3.

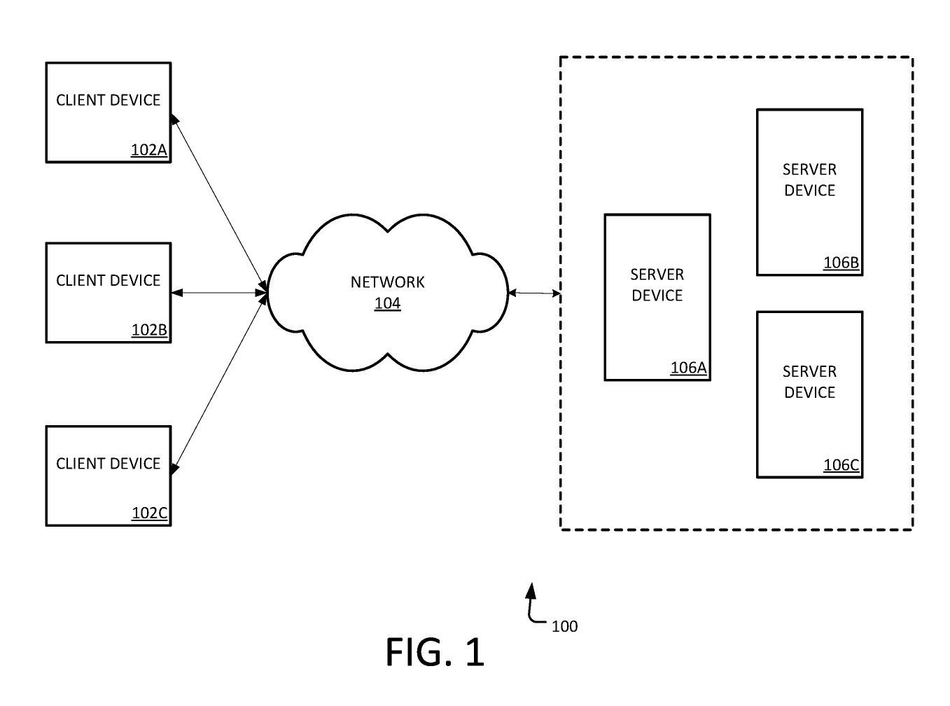

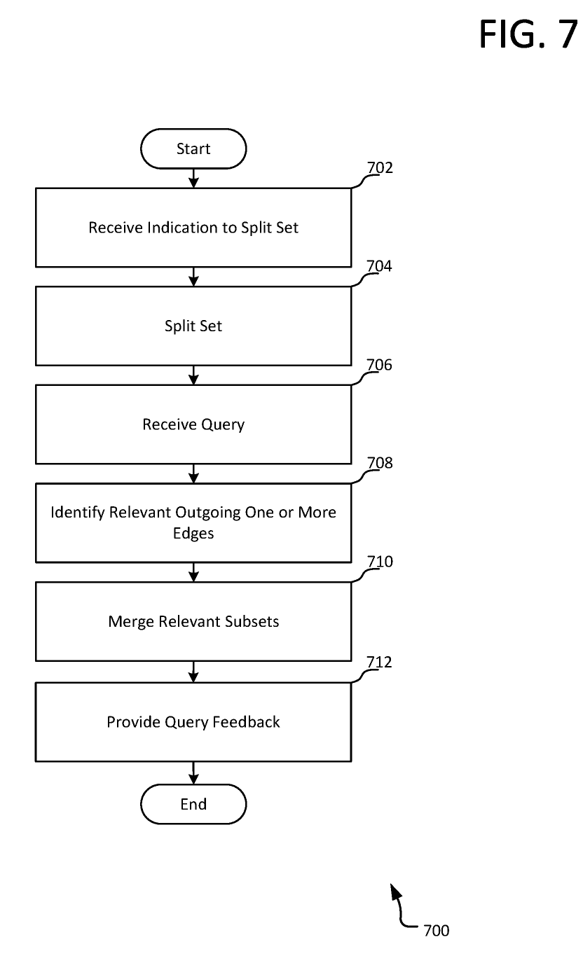

FIG. 1 illustrates an overview of an example system 100 for splitting Sets and merging subsets. Example system 100 may be a combination of interdependent components that interact to form an integrated whole for performing delegated authentication. In aspects, system 100 may include hardware components (e.g., used to execute/run operating system (OS)), and/or software components (e.g., applications, application programming interfaces (APIs), modules, virtual machines, runtime libraries, etc.) running on hardware. In particular aspects, system 100 may provide an environment for software components to execute, evaluate operational constraint sets, and utilize resources or facilities of the system 100. In such aspects, the environment may include, or be installed on, one or more processing devices. For instance, software (e.g., applications, operational instructions, modules, etc.) may be run on a processing device such as a computer, mobile device (e.g., smartphone/phone, tablet, laptop, personal digital assistant (PDA), etc.) and/or any other electronic device. As an example of a processing device operating environment, refer to the exemplary operating environments depicted in FIGS. 7-11. In other instances, the components of systems disclosed herein may be distributed across and executable by multiple devices. For example, input may be entered on a client device and information may be processed or accessed from other devices in a network (e.g. server devices, network appliances, other client devices, etc.).

As presented, system 100 comprises client devices 102A-C, distributed network 104, and a distributed server environment comprising one or more servers, such as server devices 106A-C. One of skill in the art will appreciate that the scale of systems such as system 100 may vary and may include additional or fewer components than those described in FIG. 1. In some aspects, interfacing between components of the system 100 may occur remotely, for example, where components of system 100 may be distributed across one or more devices of a distributed network.

In aspects, client devices 102A-C may be configured to receive input via a user interface component or other input means. Examples of input may include voice, visual, touch and text input. The interface component may enable the creation, modification and navigation of various data sets and graphical representations. In examples, the various datasets may comprise (or be otherwise associated with), for example, resource identifiers, resource metadata, relationship information, asserted relationships, graphical mapping information, query data, rule sets, such as, for example, inference rules, authorization information, authentication information, etc., as discussed in further detail below. Generally, the datasets are stored on one or more server devices 106A-C and are accessible by the client devices 102A-C. In some examples, however, the datasets may be at least partially stored on one or more of the client devices 102A-C. The underlying resources represented in the various datasets may be stored locally or in a data store, such as a cloud storage application, accessible to client devices 102A-C. In at least one example, the underlying resources represented in the various datasets (or portions thereof) may be distributed across client devices 102A-C. For instance, client device 102A (e.g., a mobile phone) may locally store a first portion of the resources represented in the dataset, client device 102B (e.g., a tablet) may locally store a second portion of the resources, and client device 102C (e.g., a laptop) may locally store the remaining portion of the resources represented in the dataset. In examples, the client devices 102A-C may have access to all of the resources included in the data set, may have access to a subset of the resources included in the dataset, or, alternatively, may not have access to any of the resources included in the dataset.

Client devices 102A-C may be further configured to interrogate data stores comprising the resources corresponding to the resource identifiers in the various data sets. In examples, client devices 102A-C may interrogate content providers, such as server device 106A-C, via distributed network 104. The interrogation may include identifying the remote device on which a resource is located, and/or determining whether the remote device (or a service/separate remote device) has authenticated access to the resource. If access to the resource has been authenticated, client devices 102A-C may retrieve an authentication indication from the remote device. Client devices 102A-C may use the authentication indication to provide access to one or more of the various datasets comprising the corresponding resource identifier.

Server devices 106A-C may be configured to store and/or provide access to one or more resources. For example, server device 106A may be a web server, server device 106B may be a device comprising a collaborative messaging tool and a calendaring application, and server device 106C may be electronic mail server. Each of these devices may comprise a repository of resources that is accessible via one or more authentication mechanisms. In examples, server devices 106A-C may perform or monitor the authentication process when a request for a resource is received. If the authentication is successful, the authenticating device may store or maintain an authentication indication for a specified period of time. When the period of time expires, server devices 106A-C may remove or attempt to renew the authentication indication. In examples, server devices 106A-C may provide the authentication indication to an interrogating client device. In some aspects, server devices 106A-C may further be configured to store at least a portion of the various data sets and graphical representations, as discussed above.

FIG. 2 illustrates an overview of an example system 200 for managing isolated collections of resource identifiers and corresponding relationships. The isolated collection techniques implemented in system 200 may comprise or be associated with one or more of the delegated authentication techniques described in FIG. 1. In alternative examples, a single device (comprising one or more components such as processor and/or memory) may perform the processing described in systems 100 and 200, respectively.

With respect to FIG. 2, system 200 may comprise Set creation applications 202 and 204, Set environment 206, Sets 208 and 210, entities 212 and 214, resources identifiers 216, 218, 220, 222, 224 and 226, and resources 228, 230, 232, 234, 236 and 238. In aspects, Set creation applications 202 and 204 may be an application or service configured to create, infer, manipulate, navigate and visualize various resources, relationships and graphical representations. Set creation applications 202 and 204 may define collections of relationships between resources (e.g., people, files, tasks, mail, documents, calendar events, etc.) and executing queries on those collections. Set creation applications 202 and 204 may further provide for defining and storing rule sets used to infer one or more relationships in the collections, and displaying graphical representations of the collection data. The defined rulesets may be stored in the Set itself, and in some examples is stored as metadata within the Set. In examples, Set creation applications 202 and 204 may be installed and executed on a client device or on one or more devices in a distributed environment. For instance, Set creation application 202 may be installed on client device 102A, Set creation application 204 may be installed on client device 102B, and a Set creation service associated with server device 106A may be accessible to client device 102C.

In aspects, Set creation applications 202 and 204 may have access to a file directory or an execution environment, such as environment 206. Environment 206 may be co-located with a Set creation application, or environment 206 may be located remotely from the Set creation application. Environment 206 may provide access to one or more data collections, such as Sets 208 and 210. In examples, access to the data collections may be determined using one or more sets of permissions generated and/or maintained by Set creation applications 202 and 204. The sets of permissions may be different across one or more of the data collections. As a result, one or more of the data collections (or functionality associated therewith) may not be accessible from one or more of Set creation applications 202 and 204.

Sets 208 and 210 may respectively comprise isolated collections of asserted resource identifiers and corresponding relationships. The relationships in the isolated collections may be defined manually or may be automatically derived using one or more rule sets. The isolated collections may be represented using graphical structures that directly relate resources in the data collection and provide for retrieving relationship data with a single operation. Each isolated collection may comprise resource identifiers that are unique to that isolated collection. Alternately, the isolated collections may comprise resource identifiers included in one or more alternate isolated collections. For example, as depicted in FIG. 2, Set 208 may comprise resource identifiers 216, 218, 220 and 222, and Set 210 may comprise resource identifiers 220, 222, 224 and 226. Resource identifiers 216, 218, 220, 222, 224 and 226 may correspond to, and/or identify the location of, one or more resources. As used herein, a resource identifier references an existing resource, but is not itself a resource. Exemplary types of resource identifiers include, but are not limited to, a Uniform Resource Identifier (e.g., a Uniform Resource Locator (URL), a Uniform Resource Name (URN) etc.), an IP address, a memory or storage address, and the like. One of skill in the art will appreciate that any type of identifier may be employed by the various aspects disclosed herein without departing from the scope of this disclosure. Identifying the location of a resource may include parsing the resource identifier using, for example, regular expressions, providing one or more portions of the resource identifier to a search utility, executing the resource identifier, etc. In aspects, having access to the data collections does not guarantee access to the resources identified by the resource identifiers included in each data collection. For example, although a user may be able to access and manipulate Set 208, the user may not be authorized to access one or more of the underlying resources corresponding to the resource identifier in Set 208.

Resource providers 212 and 214 may be configured to store and/or provide access to one or more resources. As such, a resource provider as used herein may be a data store, a cloud service provider, a client computing device, a server computing device, a distributed system of devices, such as, for example, an enterprise network, an application, a software platform (e.g., an operating system, a database, etc.), and the like. In aspects, resource providers 212 and 214 may be (or have access to) various different data sources, such as content providers, data stores, various sets of application data, and the like. The data stores may comprise one or more resources corresponding to one or more resource identifiers. For example, as depicted in FIG. 2, resource provider 212 may be a data store comprising various different types of resources such as resource 228 (e.g., document 1 (D1)) and resource 230 (e.g., presentation 2 (D2)) and resource provider 214 may be a contact management application comprising contact resources 232 (e.g., contact 1 (C1)), 234 (e.g., contact 2 (C2)), 236 (e.g., contact 3 (C3)) and 238 (e.g., contact 4 (C4)). In this example, resource identifier 216 may correspond to resource 228; resource identifier 218 may correspond to resource 230; resource identifier 220 may correspond to resource 232; resource identifier 222 may correspond to resource 234; resource identifier 224 may correspond to resource 236; and resource identifier 226 may correspond to resource 238. In some aspects, resource providers 212 and 214 may be accessible by Set creation applications 202 and 204. Set creation applications 202 and 204 may access resource providers 212 and 214 to determine the existence of resources and/or retrieve information associated with the resources (e.g., resource metadata, resource location, resource identifiers, permission sets, authentication data, etc.). The information retrieved from resource providers 212 and 214 may be used to determine a set of resource identifiers corresponding to one or more of the available resources. The set of resource identifiers may be used to create one or more isolated collections of asserted resource identifiers and corresponding relationships. As noted above, the resource identifiers may be, or include, a durable URI for its corresponding resource. For instance, the resource identifier 216 may include the URI for the actual document (D1) 228. Accordingly, in such an example, a user is able to determine the location of the document (D1) 228 from the Set, and, depending on authentication and access restrictions, retrieve the document (D1) 228. As another example, as depicted in FIG. 2, resource provider 212 may be accessed by Set creation application 202. Set creation application 202 may determine that resource provider 212 comprises at least resources 228 and 230, and may determine resource identification information for each of the resources. Based on the determined resource identification information, resource identifiers 216 and 218 may be respectively applied/correlated to resources 228 and 230, and provided to environment 206. Environment 206 may then make resource identifiers 216 and 218 eligible for an inclusion analysis into one or more isolated collections.

FIG. 3A illustrates an example isolated collection 300 of asserted resource identifiers and corresponding relationships. Example isolated collection 300 comprises resource identifiers 302, 304, 306, 308, 310, 312 and 314, and relationships 316, 318, 320, 322, 324 and 326. In aspects, isolated collection 300 may be generated and/or manipulated using a collection creation utility that may be included as part of a Set creation application as discussed above. When presented in graph form as depicted in the FIG. 3A, each resource identifier may be referred to as a “node” and each relationship may be referred to as an “edge.” The collection creation utility may also identify resources and/or determine resource types for collections using one or more rule sets that may include rules defined in accordance with semantic web technologies, such as resource description framework (RDF), RDF schema (RDFS), SPARQL Protocol and RDF Query Language (SPARQL), Web Ontology Language (OWL), etc. For example, collection 300 includes a resource identifier 312 that represents an underlying resource, “emai1789” in the depicted example. Similarly, resource identifier 304 represents a resource document, “Doc123,” and resource identifier 302 represents a resource task, “Task123.” Each of the resources and relationships included in the isolated collection 300 may have been asserted by a developer through a Sets creation application. For instance, a developer may manually add each of the resource identifiers and the relationships between the resource identifiers. As an example, the developer may manually indicate that the “task123” is a task on “Doc123,” as represented in the collection 300 by the “taskOn” relationship 316. The resource identifiers and relationships may also be asserted by an external bot or application created by a developer. For instance, an add-in may be programmed to monitor activity in a browser or other application to track usage of the application. Based on the usage of the application, the add-in sends additional resources and relationships to be included in the collection 300.

In contrast to the asserted resource identifiers and relationship, a collection creation utility may execute a ruleset to determine additional relationships and resource types, referred to herein as “inferred relationships” and “inferred resource identifiers” or “inferred resource types.” For example, upon execution of a ruleset, the collection creation utility may determine that resource identifier 312 represents an email message, and resource identifier 304 represents a document. Generation of inferred relationships and resources is discussed in further detail below.

Isolated collection 300 further depicts that resource identifier 302 is associated with resources identifiers 304, 306 and 308 and resource identifier 310. The collection creation utility may determine that the resource identifier 302 represents a task to be performed on identifiers 304, 306, and 308. Based on this determination, the collection creation utility may assign relationships 316, 318 and 320 (e.g., “taskOn”) to define the association between resource identifier 302 and resource identifier 304, 306 and 308. In other examples, the relationships 316, 318, and 320 may be asserted, as discussed above. Additional relationships, such as the “hasDiscussion” relationship 322 may have been asserted manually by a developer or asserted from an add-in of an e-mail application that analyzed the content of e-mail 101. While specific types of resources and relationships are described in FIG. 3A, one of skill in the art will appreciate that other types of resources and/or relationships may be included in an isolated collection without departing from the spirit of this disclosure.

FIGS. 3B-3E illustrate an example query model that may be used to traverse collection 300. In aspects, queries may be executed via an interface provided by the collection creation utility. A query may be executed against one or more files and/or directories comprising information, such as resource identifiers, resource type, resource metadata, permission data, etc. The query results may be visualized in a graph form as one or more collections, such as collection 300. For example, the entire collection 300 dataset may comprise only those elements illustrated in collection 300 (e.g., resource identifiers 302, 304, 306, 308, 310, 312 and 314 and relationships 316, 318, 320, 322, 324 and 326). In this particular example, resource identifier 312 may represent an email comprising the subject “API Design” and resource identifier 314 may represent an email comprising the subject “Sets.” The query ‘http://.../collection300/task123’ may be executed against collection 300. The query results may comprise resource identifier 302 and be visualized as illustrated in FIG. 3B. In FIG. 3C, the query has been amended to ‘http://.../collection300/task123?$expand=taskOn’ and executed against collection 300. The query results may comprise resource identifiers 302, 304, 306 and 308 and relationships 316, 318 and 320, and be visualized as illustrated in FIG. 3C. In FIG. 3D, the query has been amended to ‘http://.../collection300/task123?$expand=taskOn(Sexpand=attachmentOn)’ and executed against collection 300. The query results may comprise resource identifiers 302, 304, 306, 308, 312 and 314 and relationships 316, 318, 320, 324 and 326, and be visualized as illustrated in FIG. 3D. In FIG. 3E, the query has been amended to ‘http://.../collection300/task123?$expand=taskOn(Sexpand=attachmentOn(Sfilter=Subject eq ‘Sets’))’ and executed against collection 300. As only resource identifier comprises 314 the subject “Sets”, the query results may comprise resource identifiers 302, 306 and 314 and relationships 318 and 326, and be visualized as illustrated in FIG. 3E.

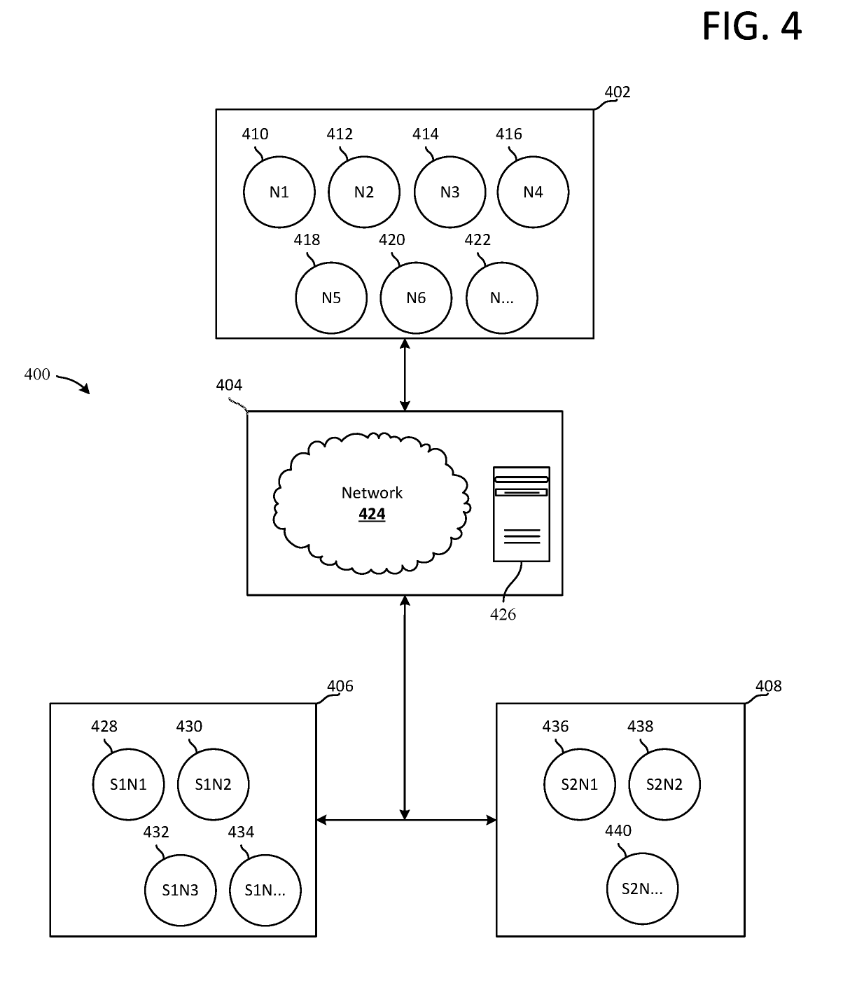

FIG. 4 illustrates an exemplary distributed computing environment 400 for splitting and merging graphical data sets. Distributed computing environment 400 includes original Set 402, Set processing environment 404, subset one 406 and subset two 408. Original Set context 402 includes nodes N1 410 through node N . . . 422, which comprise a Set prior to its subsequent split into subset one 406 and subset two 408. Each of nodes N1 410 through node N . . . 422 in original Set 402 may be stored on a storage array, such as one or more storage devices on one or more server computing devices. Additionally or alternatively, each of nodes N1 410 through node N . . . 422 may be stored locally on one or more local computing devices such as a laptop, tablet or smart phone.

According to examples, certain information corresponding to a node in original Set 402 may be associated with each node in the Set as a tuple. For example, one element of a tuple for a node may provide a unique node identifier, such as a number, a letter, a symbol, a URI, a URI that references a number, a letter, a symbol or a combination of the same associated with a node, or a combination of the like. According to the Set shown in original Set 402, the nodes therein include node identifiers N1 for node 410, N2 for node 412, N3 for node 414, N4 for node 416, N5 for node 418, N6 for node 420 and N . . . for nodes 422.

Another element of a tuple for a node may represent relationships that each node of a Set has to other nodes in the Set. The relationships may relate to the attributes that nodes in the Set have in common such as associated party attributes, locational attributes, temporal attributes, topical attributes, and associated task attributes, among others.

A third element of a tuple for a node may be an object associated with the node, which may provide a value for an attribute or a designation that points to another node in the database. For example, if the second element in a tuple for a node associates a temporal or “date” attribute with the node, a value may be provided for that attribute as it relates to a property of its corresponding resource. Alternatively, if the third element in the tuple provides a designation that points to another node in the Set, that designation may denote a value for the property in the second element of the tuple which may be located by referencing the value of the other node in the Set (e.g., “valNodeID”). In another example, the third element may simply reference a node identifier of another node in the Set.

The Set comprising nodes N1 410 through node N . . . 422 in original Set 402 may grow over time as additional resources are added to it and/or as additional classification of existing resource properties are indexed within the Set as attributes of their corresponding nodes. As such, it may be desirable or necessary to split the Set into a plurality of subsets if and when the storage array hosting the Set is nearing capacity or a storage threshold is met or exceeded as it relates to the Set and the storage array.

Upon making a determination, based on the storage threshold being met or exceeded, that the Set should be split into a plurality of subsets, the Set may be split by one or more computing devices. For example, the Set may be passed to a computing device, such as server computing device 426 via network 424, and the Set may be split for storage on one or more secondary storage arrays.

When a determination has been made to split a Set, such as original Set 402, the Set may be split at a location within the tuples that represent the Set such that the corresponding subsets are optimized for distributed storage on the original storage array and the one or more secondary storage arrays. The split may occur at a node boundary (i.e., the tuple boundary that separates a first node from a second node) or a tuple level boundary for a node (i.e., between tuples for a single node). In either case, the outgoing edges (i.e., a tuple that links a source node to a target node) for each subset are preserved in order to facilitate subsequent merging of subsets upon receiving a query that relates to a plurality of split subsets.

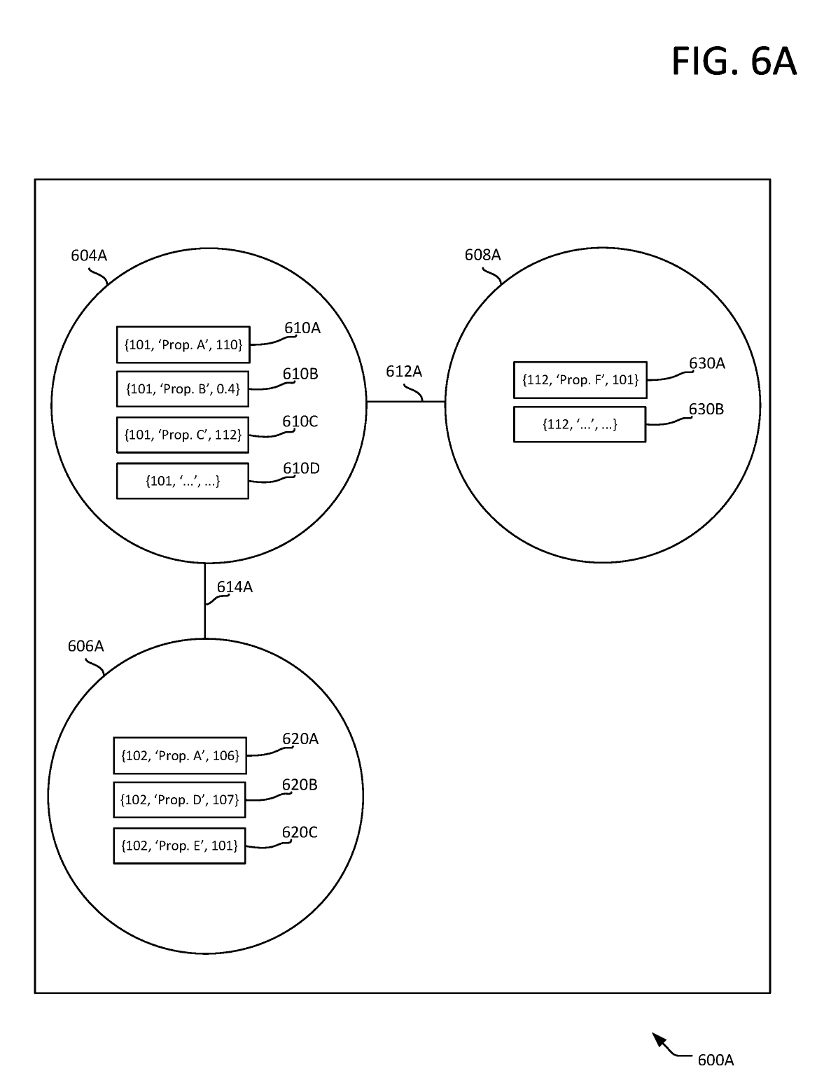

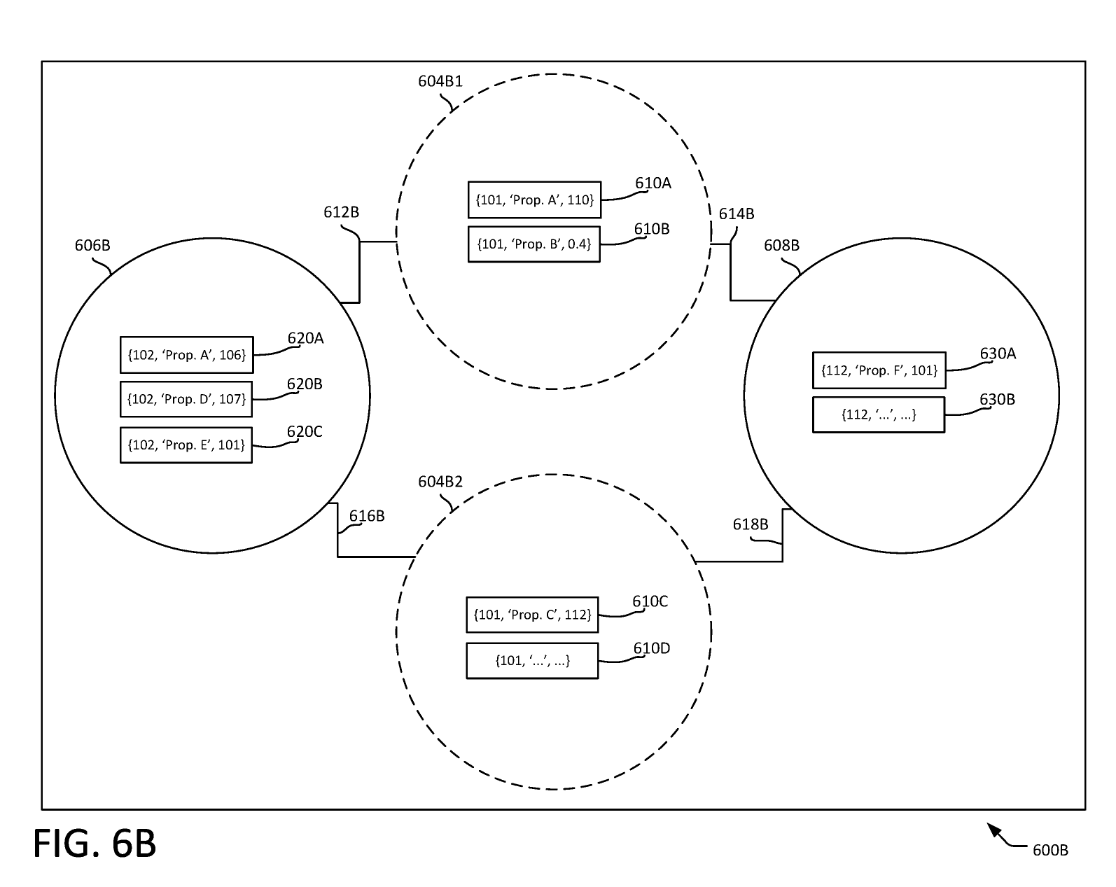

According to the example shown in FIG. 4, after a determination has been made that original Set 402 should be split into a plurality of subsets, one or more computing device, such as server computing device 426, may split the Set, and a plurality of subsets may be split from the Set. In this example, original Set 402 has been split into a first subset 406, and a second subset 408. The first subset 406 includes S1N1 (subset 1, node 1) node 428, S1N2 node 430, S1N3 node 432 and S1N . . . nodes 434. The second subset 408 includes S2N1 (subset 2, node 1) node 436, S2N2 node 438 and S2N . . . nodes 440. As discussed below with specific regard to FIGS. 6A-FIG. 7, the first subset 406 and second subset 408 may be subsequently merged in response to receiving a query that relates to information contained in each of those subsets.

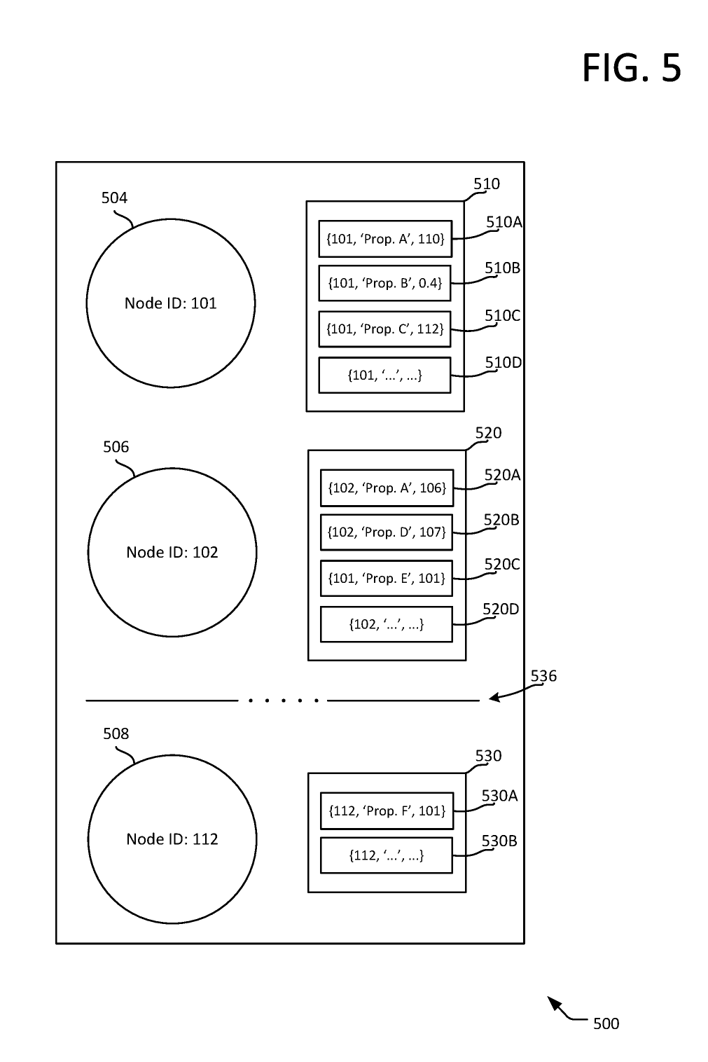

FIG. 5 illustrates three exemplary nodes of a Set 500 and their corresponding tuple information prior Set 500 being split. A first node 504 of Set 500 has node ID: 101 and associated tuple information 510. Associated tuple information for the first node 504 includes first tuple information 510A, second tuple information 510B, third tuple information 510C and fourth tuple information 510D. A second node of the Set 500 has a node ID: 102 and associated tuple information 520. Associated tuple information for the second node 506 includes fifth tuple information 520A, sixth tuple information 520B, seventh tuple information 520C and eighth tuple information 520D.

The third node of Set 500 has a node ID: 112 and associated tuple information 530. Associated tuple information for the third node 508 includes ninth tuple information 530A and tenth tuple information 530B.

The first element in each of tuples 510A-510D, 520A-520D, and 530A-530B comprises a node ID for each corresponding node (i.e., nodes 504, 506 and 508 corresponding to node IDs 101, 102, 112). The second element in each of tuples 510A-510D, 520A-520D, and 530A-530B comprises an attribute corresponding to a property of each resource that a corresponding node has been generated for (i.e., nodes 504, 506, and 508). For example, “Prop. A” in tuple information 510A and 520A may correspond to a temporal attribute that both nodes 504 and 506 have in common. Similarly, “Prop. B” in tuple information 510B may correspond to a topical attribute that is not shared with any other node in Set 500. Likewise, “Prop. C” in tuple information 510C may correspond to a locational attribute that is not shared with any other node in Set 500.

The third element in each of tuples 510A-510D, 520A-520D, and 530A-530B may comprise a value for an attribute or a designation that points to another node in Set 500. For example, if the second element in the tuple associates a temporal or “date” attribute with a node, a value may be provided for that attribute as it relates to a property of the resource. Alternatively, if the third element in the tuple provides a designation that points to another node in the database, that designation may denote a value for the property in the second element of the tuple which may be located by referencing the value of the other node in Set 500. In another example, the third element may simply reference a node identifier of another node in Set 500.

A dividing line 536 shows for, illustrative effect, that there may be one or more additional nodes in Set 500 between second node 506 and third node 508.

FIG. 6A illustrates the relationships that three exemplary nodes 604A, 606A, and 608A of Set 600A have amongst one another prior to Set 600A being split. Node 604A and its corresponding tuple elements correspond to node 504 in FIG. 5, node 606A and its corresponding tuple elements correspond to node 506 in FIG. 5, and node 608 and its corresponding tuple elements correspond to node 508 in FIG. 5.

Node 604A is related to node 606A based on tuple elements that are shared amongst one another. Specifically, the third tuple element of tuple information 620C comprises a node identifier that references node 604A. That is, tuple information 620C is an outgoing edge from node 606A (with node ID: 102) to node 604A (with node ID: 101). Node 604A is also related to node 606A because the property designated by tuple information 610A (“Prop. A”) for node 604A is the same as the property designated in the second element of tuple information 620A for node 606A. Similarly, node 608A is related to node 604A because the third tuple element of tuple information 630A for node 608A comprises a node identifier that references node 604A. That is, tuple information 610C is an outgoing edge from node 604A (with node ID: 101) to node 608A (with node ID: 112).

FIG. 6B illustrates the relationships that the three exemplary nodes 604A, 606A, and 608A of FIG. 6A have after splitting Set 600A at the tuple level of node 604A. The nodes illustrated in FIG. 6B have been split to comprise the multi-subset environment 600B. Specifically, Set 600A has been split at the tuple level between tuple information 610B and tuple information 610C of node 604A. That is, node 604A of FIG. 6A has been split into two corresponding nodes such that tuple information for node 604A is divided into node 604B1 (having tuple information 610A and tuple information 610B) and node 604B2 (having tuple information 610C and 610D).

According to examples, because the tuple set that comprised Set 600A was split at the tuple level of node 604A, the first portion of split Set 600A (i.e., tuple information 610A and 610B) may be stored on a first storage array which may or may not be the same storage array that originally stored Set 600A, and the second portion of split Set 600A (i.e., tuple information 610C, 610D, 620A, 620B, 620C, 630A, and 630B) may be migrated and stored on one or more secondary storage arrays. That is, node 604B1 and its corresponding tuple information 610A and 610B may remain on its original storage array and nodes 606B, 608B and 604B2 and their corresponding tuple information (620A, 620B and 620C for node 606B; 630A and 630B for node 608B; and 610C and 610D for node 604B2) may be migrated to one or more secondary storage arrays. Thus, node 604B1 may comprise a first subset of Set 600A and nodes 606B, 608B and 604B2 may comprise a second subset of Set 600A after splitting Set 600A.

Node 604B1, which may comprise a first subset of Set 600A, may be merged with a second subset of Set 600A comprising nodes 606B, 608B and 604B2. That is, node 604B1, in the first subset, is related to nodes 606B and 608B in the second subset and a received query relating to both subsets and the relationships between nodes 604B1 and node 606B and/or node 608B may be received and the first and second subsets may be merged in a lazy manner based on that received query.

Node 604B1 is related to node 608B through relationship 614B based on tuple elements that are shared amongst one another. Specifically, the third tuple element of tuple information 630A comprises a node identifier that references node 604B1. Node 604B1 is also related to node 606B, through relationship 612B, because the property designated by tuple information 610A (“Prop. A”) for node 604B1 is the same as the property designated in the second element of tuple information 620A for node 606B. Similarly, Node 604B1 is also related to node 606B, through relationship 612B, and node 604B2, through relationship 616B, because the third element of tuple information 620C is an outgoing edge referencing the node ID (i.e., ID 101) for both of nodes 604B1 and 604B2.

Node 604B2 is similarly related to node 608B through relationship 618B based on tuple elements that are shared amongst one another. Specifically, the third element of tuples 620C and 630A comprise a node identifier that references node 604B2 and node 604B1.

One or more queries may be received which reference a relationship amongst a split Set, such as multi-subset environment 600B. Upon receiving such a query, information from each of the subsets that is likely to provide useful information in providing relevant feedback based on the query may be lazily retrieved.

According to examples, the following lazy merge graph queries and associated feedback may be received and provided based on obtaining information from one or more subsets represented by the multi-subset environment 600B. Specifically, the two subgraphs are subgraph one (comprising node 604B1), and subgraph two (comprising nodes 606B, 604B2, and 608B).

Query 1: GetRelationships(101)

Feedback 1 for subgraph one prior to lazy merge: [Prop. A]

Feedback 1 for subgraph two prior to lazy merge: [Prop. C]

Feedback 1 after lazy merge: [Prop. A, Prop. C]

Query 2: GetRelated (101, Prop. A)

Feedback 2: [110]

Query 3: GetProperties (101)

Feedback 3: {Prop. B: 0.4}

FIG. 7 is an exemplary method 700 for splitting and merging a Set. The method 700 begins at a start operation and continues to operation 702 where an indication to split a Set is received. An indication to split the Set may be made based on a determination that the array that the Set is being stored on may not be sufficient based on its own storage and performance capabilities and/or the storage and performance capabilities of one or more secondary storage devices associated with available secondary storage arrays. For example, a threshold may be implemented that specifies, based on the current size of the Set, the growth rate of the Set, the amount of storage left on a storage device hosting the Set, the amount of storage available for the Set or the Set type, etc., that the Set should be split when a split threshold has been met or exceeded as it relates to one or more of such factors. The command to split such the Set may be made by a database administrator or an automated mechanism based on the threshold being met or exceeded.

From operation 702, flow continues to operation 704 where the Set is split into a plurality of subsets. The determination of where to split the Set (e.g., how much of the Set will be split and stored on one or more secondary storage arrays, whether to split the set at a node boundary or a tuple level boundary for a node, etc.) may be made based upon storage devices that are determined to be available for storage and/or the storage and performance of those arrays.

For example, at operation 704, after a determination has been made to split a Set, the Set may be split at a location within the tuples that represent the Set such that the corresponding subsets are optimized for distributed storage on an original storage array and/or one or more secondary storage arrays. The split may occur at a node boundary (i.e., the tuple boundary that separates a first node from a second node) or a tuple level boundary for a node (i.e., between tuples for a single node). In either case, the outgoing edges for each subset are preserved in order to facilitate subsequent merging of subsets upon receiving a query that relates to a plurality of split subsets.

Moving from operation 704, flow continues to operation 706 where a query related to the Set is received. A query that potentially references a plurality of subsets may result in the merging of those subsets. For example, data set queries that may result in the merging of subsets include the following:

string[_] GetRelationships (id, anchor);

string[_] GetRelated (id, rel, anchor);

KVP[ ] GetProperties (id); and

bool Contains (id).

In the above exemplary query types “[ ]” denotes a subset with a stable order. The stable order is ensured with a comparer. “[ ]” denotes an unordered collection. “anchor” is an optional parameter that is used to set a named starting point. “GetRelationships(id)” may return [rel abc], with “rel abc” corresponding to the relationship name, and “GetRelated” provide a mechanism for retrieving a node's outgoing immediate relationships and that retrieval is performed through lazy evaluation. To list tuple IDs in a graph, the string “GetRelated(graphName|ID, ‘member’)” may be input.

A “MergeGraph” operation may implement a “QueryGraph” operation and have two inner query graphs. For the “GetRelated” operation, a merge of the “First.GetRelated” operation and the “Second.GetRelated” will result, while preserving the order. The comparer in this scenario is also the comparer to determine the stable order of the returned collection. Thus, in a query such as “GetRelated (id, rel abc) will return node IDs for each node in each subset that contains “rel abc” in its corresponding tuple, while maintaining the order of the original data set from which the subsets were split. According to additional examples, if a “GetProperties” query is received that returns conflicting values for a single property, metadata or a schema associated with the data set/graph may be used to determine a merge policy for those values (e.g., concatenation, union, overwrite).

From operation 706, flow continues to operation 708 where one or more outgoing edges relevant to the received query are identified. An outgoing edge may comprise a tuple element related to first node that shares an attribute with or references a tuple element with a second node. For example, a tuple element for a first node that is a “property” element, may contain information related to a first property of a resource that the node represents, and a tuple element for a second node that is a “property” element may have that property element in common with the first node (e.g., the shared property element relate to a shared temporal or locational property for the corresponding resources for the first and second nodes). This relationship may identify an outgoing edge between the first and second nodes that is preserved after a split of a Set containing each of those nodes.

Similarly, an outgoing edge may comprise a tuple element that points to another node in a Set. For example, if a tuple element for a first node associates a temporal or locational attribute with that node, a value may be provided for that attribute as it relates to a property of a corresponding node resource. In another example, if a tuple element for a first node provides a designation that points to a second node in a Set, that designation may denote a value for the property which may be located by retrieving the value set forth in the designated second node (e.g., “valNodeID of second node”). In yet another example, a tuple element for a first node may simply reference a node identifier of second node in the Set (e.g., “node id”). Each of these relationships may represent an outgoing edge that would be preserved upon splitting a Set at operation 704.

Continuing from operation 708, flow continues to operation 710 where one or more subsets are merged based on which subsets from the split Set are identified as being relevant to the query. That is, when a query is identified as referencing related nodes in two or more subsets, it may be necessary to obtain relevant information related to that query by merging the subsets that contain the related nodes. Multiple subsets may be merged into one collection by lazily evaluating tuple information (i.e., outgoing edges) related to such a query. That is, a subset may only be called for information related to a query when it is needed and a value may only be provided as feedback to the query during a merge of the relevant subsets when a tuple containing that information is identified.

From operation 710, flow continues to operation 712 where feedback related to the query is provided. Feedback to the query may be provided by way of a graphical user interface on a display that a user is utilizing in interacting with a Set, an audio system associated with a computing device that a user is utilizing in interacting with a Set, haptic elements associated with a computing device that a user is utilizing interacting with a Set, etc.

From operation 712, flow continues to an end operation and the method 700 ends.

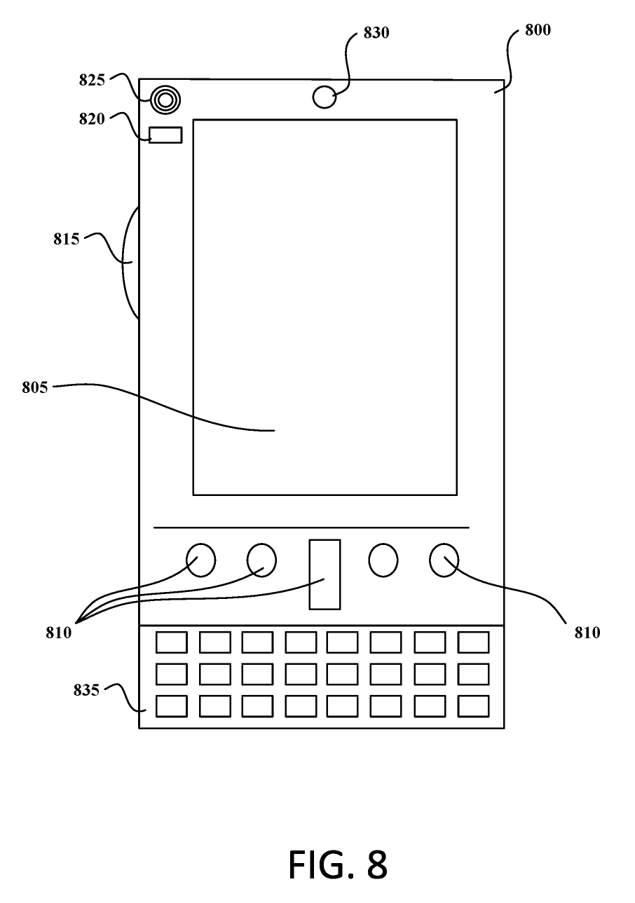

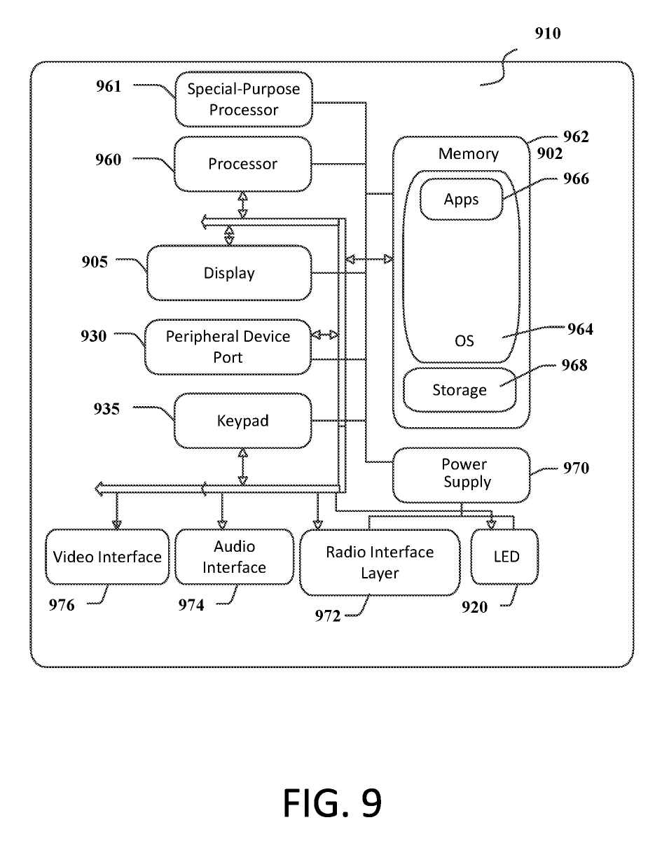

FIG. 8 and FIG. 9 illustrate computing device 800, for example, a mobile telephone, a smart phone, a tablet personal computer, a laptop computer, and the like, with which embodiments of the disclosure may be practiced. With reference to FIG. 8, an exemplary mobile computing device 800 for implementing the embodiments is illustrated. In a basic configuration, the mobile computing device 800 is a handheld computer having both input elements and output elements. The mobile computing device 800 typically includes a display 805 and one or more input buttons 810 that allow the user to enter information into the computing device 800. The display 805 of the mobile computing device 800 may also function as an input device (e.g., a touch screen display). If included, an optional side input element 815 allows further user input. The side input element 815 may be a rotary switch, a button, or any other type of manual input element.

In alternative embodiments, mobile computing device 800 may incorporate more or less input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display.

In various embodiments, the output elements include the display 805 for showing a graphical user interface (GUI), a visual indicator 820 (e.g., a light emitting diode) and/or an audio transducer 825 (e.g., a speaker). In some embodiments, the mobile computing device 800 incorporates a vibration transducer for providing the user with tactile feedback. In yet another embodiments, the mobile computing device 800 incorporates input and/or output ports, such as an audio input (e.g., a microphone jack), an audio output (e.g., a headphone jack), and a video output (e.g., a HDMI port) for sending signals to or receiving signals from an external device. In embodiments, the word processing application may be displayed on the display 805.

FIG. 9 is a block diagram illustrating the architecture of one embodiment of a mobile computing device. That is, the mobile computing device 900 can incorporate a system (i.e., an architecture) 902 to implement some aspects of the disclosure. In one aspect the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and a wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, diagramming applications, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like.

A synchronization application (not shown) also resides on the system 902 and is programmed to interact with a corresponding synchronization application resident on a host computer to keep the information stored in the non-volatile storage area 968 synchronized with corresponding information stored in the host computer. As should be appreciated, other applications may be loaded into the memory 962 and run on the mobile computing device 900, including steps and methods for providing personalized feedback from voice analysis and other user input.

The system 902 has a power supply 970, which may be implemented as one or more batteries. The power supply 970 might further include an external power source, such as an AC adapter or a powered docking cradle that supplements or recharges the batteries.

The system 902 may also include a radio 972 that performs the functions of transmitting and receiving radio frequency communications. The radio 972 facilitates wireless connectivity between the system 902 and the “outside world,” via a communications carrier or service provider. Transmissions to and from the radio 972 are conducted under control of the operating system 964. In other words, communications received by the radio 972 may be disseminated to the application programs 966 via the operating system 964, and vice versa. The radio 972 allows the system 902 to communicate with other computing devices such as over a network. The radio 972 is one example of communication media. Communication media may typically be embodied by computer readable instructions, data structures, program modules, or other data in a modulated data signal, such as a carrier wave or other transport mechanism, and includes any information deliver media. The term “modulated data signal” means a signal that has one or more of its characteristics set or changed in such a manner as to encode information in the signal. By way of example, not limitation, communication media includes wired media such as a wired network or direct-wired connection, and wireless media such as acoustic, RF infrared and other wireless media. The term computer readable media is used herein includes both storage media and communication media.

This embodiment of the system 902 provides notifications using the visual indicator 820 that can be used to provide visual notifications and/or an audio interface 974 producing audible notifications via the audio transducer 825. In the illustrated embodiment, the visual indicator 820 is a light emitting diode (LED) and the audio transducer 825 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 825, the audio interface 974 may also be coupled to a microphone to receive audible input, such as to facilitate a telephone conversation. In accordance with embodiments of the present invention, the microphone may also serve as an audio sensor to facilitate control of notifications, as will be described below. The system 902 may further include a video interface 976 that enables an operation of an on-board camera 830 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9 by the non-volatile storage area 968. Computer storage media may include volatile and nonvolatile, removable and non-removable media implemented in any method or technology for storage of information, such as computer readable instructions, data structures, program modules, or other data.

Data/information generated or captured by the mobile computing device 900 and stored via the system 902 may be stored locally on the mobile computing device 900, as described above, or the data may be stored on any number of storage media that may be accessed by the device via the radio 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio 972 or via a distributed computing network. Similarly, such data/information may be readily transferred between computing devices for storage and use according to well-known data/information transfer and storage means, including electronic mail and collaborative data/information sharing systems.

One of skill in the art will appreciate that the scale of systems such as system 902 may vary and may include more or fewer components than those described in FIG. 9. In some examples, interfacing between components of the system 902 may occur remotely, for example where components of system 902 may be spread across one or more devices of a distributed network. In examples, one or more data stores/storages or other memory are associated with system 902. For example, a component of system 902 may have one or more data storages/memories/stores associated therewith. Data associated with a component of system 902 may be stored thereon as well as processing operations/instructions executed by a component of system 902.

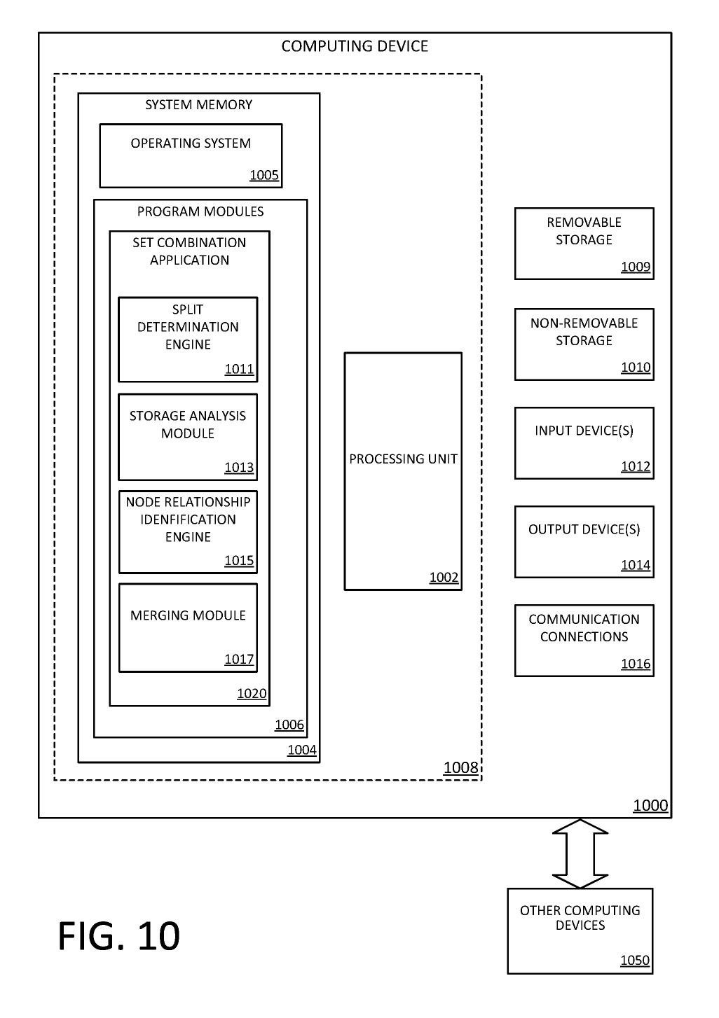

FIG. 10 is a block diagram illustrating physical components (e.g., hardware) of a computing device 1000 with which aspects of the disclosure may be practiced. The computing device components described below may have computer executable instructions for merging a plurality of subsets split from a first set, comprising: receiving a query, the query specifying one or more relationships between a node in a first subset of the plurality of subsets and a node in a second subset of the plurality of subsets; identifying, from the node in the first subset, an outgoing edge to the second subset, the outgoing edge corresponding to at least one of the one or more relationships common to the node in the first subset and the node in the second subset; merging the first subset and the second subset; and providing feedback related to the node in the second subset corresponding to the query.

In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 and one or more program modules 1006 suitable for set combination application 1020, such as one or more components in regards to FIG. 10 and, in particular, split determination engine 1011, storage analysis module 1013, node relationship identification engine 1015 and merging module 1017. For example, split determination engine 1011 may perform one or more operations related to identifying whether a threshold has been met or exceeded, whereby the threshold provides a mechanism for determining that a Set should be split for storage on one or more secondary storage arrays. Storage analysis engine 1013 may perform one or more operations related to identifying performance and storage capabilities of storage devices available for storing one or more subset of a Set. Node relationship identification module 1015 may perform operations that evaluate tuples for nodes in a Set or one or more subset and determining whether one or more nodes have a relationship to one another. Merging module 1017 may perform one or more operations in performing lazy evaluation of tuples from a Set or one or more subset that relate to a received query.

The operating system 1005, for example, may be suitable for controlling the operation of the computing device 1000. Furthermore, aspects of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., set combination application 1020) may perform processes including, but not limited to, the aspects, as described herein.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

As stated above, a number of program modules and data files may be stored in the system memory 1004. While executing on processing unit 1002, program modules (e.g., applications, Input/Output (I/O) management, and other utilities) may perform processes including, but not limited to, one or more of the operational stages of the methods described herein.

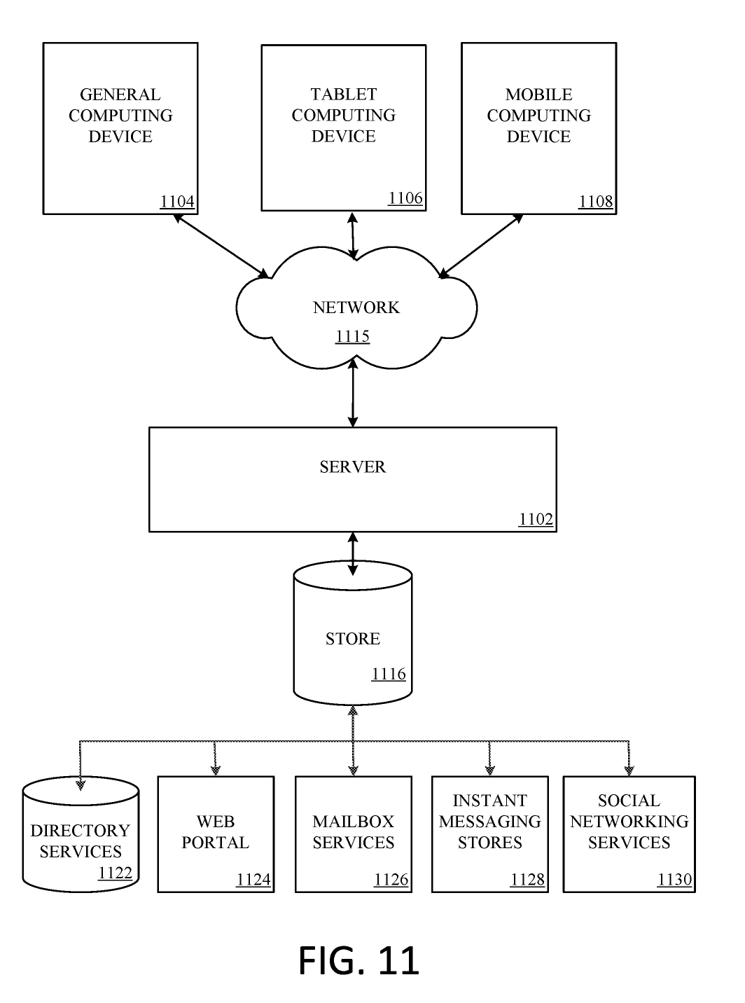

FIG. 11 illustrates one example of the architecture of a system for merging a plurality of subsets split from a first set as described herein. User input may be accessed, interacted with, or edited in association with programming modules 1006 and storage/memory which may be stored in different communication channels or other storage types. For example, various documents may be stored using a directory service 1122, a web portal 1124, a mailbox service 1126, an instant messaging store 1128, or a social networking site 1130, application 1006, an IO manager, other utilities and storage systems may use any of these types of systems or the like for enabling data utilization, as described herein. A server 1102 may provide a storage system for use by a client operating on a general computing device 1104 and mobile computing devices 1106 through network 1115.

According to examples, one or more resource may be received on general computing device 1104 and a query for information related to those resources and their corresponding graphical node set or subsets may be provided via one or more mobile computing device 1106. One or more Sets or subsets may be stored on server 1102 and relationships amongst nodes may be identified by processing performed by server 1102. According to additional examples, network 1115 may comprise the Internet or any other type of local or wide area network, and client nodes may be implemented as a computing device embodied in a personal computer, a tablet computing device 1106, and/or by a mobile computing device 1108 (e.g., mobile processing device). Any of these examples of the computing devices described herein may obtain content from the store 1116.

As will be understood from the foregoing disclosure, one aspect of the technology relates to a method for merging a plurality of subsets split from a first set, comprising: receiving a query, the query specifying one or more relationships between a node in a first subset of the plurality of subsets and a node in a second subset of the plurality of subsets; identifying, from the node in the first subset, an outgoing edge to the second subset, the outgoing edge corresponding to at least one of the one or more relationships common to the node in the first subset and the node in the second subset; merging the first subset and the second subset; and providing feedback related to the node in the second subset corresponding to the query. In an example, the first subset and the second subset each contain data that was contained in a single node in the first set. According to another example, the first subset and the second subset were split from the first set at a node identification boundary. According to other examples, the one or more relationships between the node in the first subset and the node in the second subset are selected from: a node identifier and a node attribute. According to yet other examples, the one or more relationships between the node in the first subset and the node in the second subset relate to elements of tuples common to one another. In some examples, the first subset is stored on a first storage array and the second subset is stored on a second storage array. In another example, a determination to split the first set is based on storage capabilities of a storage array on which the first set is stored and the size of the first set. In still further examples, the relative amounts of data split into the first subset and the second subset is based on storage capabilities a first storage array on which the first set is stored and the capabilities of a second storage array on which the first and second subsets are to be stored after splitting the first set. In other examples, the merging the first subset and the second subset is performed by lazy evaluation. According to other examples, the query contains an anchor denoting a starting point for identifying a node in the second subset having a relationship to a node in the first subset. In another example, the one or more relationships is a shared node attribute having conflicting values in the first subset and the second subset, and a merge policy is utilized in determining a mechanism by which to merge the first subset and the second subset, the merge policy determined based on a schema by which data in the first subset and second subset is stored. In further examples, the merge policy is selected from: a concatenation policy, a union policy, and an overwrite policy.

In another aspect, the technology relates to a system for merging a plurality of subsets split from a first set, comprising: a memory for storing executable program code; and a processor, functionally coupled to the memory, the processor being responsive to computer-executable instructions contained in the program code and operative to: receive a query, the query specifying one or more relationships between a node in a first subset of the plurality of subsets and a node in a second subset of the plurality of subsets; identifying, from the node in the first subset, an outgoing edge to the second subset, the outgoing edge corresponding to at least one of the one or more relationships common to the node in the first subset and the node in the second subset; merging the first subset and the second subset; and providing feedback related to the node in the second subset corresponding to the query. According to some examples, the first subset and the second subset each contain data that was contained in a single node in the first set. According to other examples, the one or more relationships between the node in the first subset and the node in the second subset relate to elements of tuples common to one another. According to yet other examples, a determination to split the first set is based on storage capabilities of a storage array on which the first set is stored and the size of the first set. According to another example, the one or more relationships is a shared node attribute having conflicting values in the first subset and the second subset, and a merge policy is utilized in determining a mechanism by which to merge the first subset and the second subset.

In another aspect, the technology relates a computer-readable storage device comprising executable instructions, that when executed by a processor, assist with merging a plurality of subsets split from a first set, the computer-readable medium including instructions executable by the processor for receiving a query, the query specifying one or more relationships between a node in a first subset of the plurality of subsets and a node in a second subset of the plurality of subsets; identifying, from the node in the first subset, an outgoing edge to the second subset, the outgoing edge corresponding to at least one of the one or more relationships common to the node in the first subset and the node in the second subset; merging the first subset and the second subset; and providing feedback related to the node in the second subset corresponding to the query. According to some examples the first subset and the second subset each contain data that was contained in a single node in the first set. According to other examples, the determination to split the first set is based on storage capabilities of a storage array on which the first set is stored and the size of the first set.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method for merging a plurality of subsets split from a first set, comprising:
receiving a query, the query specifying one or more relationships between a node in a first subset of the plurality of subsets and a node in a second subset of the plurality of subsets;
identifying, from the node in the first subset, an outgoing edge to the second subset, the outgoing edge corresponding to at least one of the one or more relationships common to the node in the first subset and the node in the second subset;
merging the first subset and the second subset; and
providing feedback related to the node in the second subset corresponding to the query.

2. The method of claim 1, wherein the first subset and the second subset each contain data that was contained in a single node in the first set.

3. The method of claim 1, wherein the first subset and the second subset were split from the first set at a node identification boundary.

4. The method of claim 1, wherein the one or more relationships between the node in the first subset and the node in the second subset are selected from: a node identifier and a node attribute.

5. The method of claim 1, wherein the one or more relationships between the node in the first subset and the node in the second subset relate to elements of tuples common to one another.

6. The method of claim 1, wherein the first subset is stored on a first storage array and the second subset is stored on a second storage array.

7. The method of claim 1, wherein a determination to split the first set is based on storage capabilities of a storage array on which the first set is stored and the size of the first set.

8. The method of claim 1, wherein the relative amounts of data split into the first subset and the second subset is based on storage capabilities a first storage array on which the first set is stored and the capabilities of a second storage array on which the first and second subsets are to be stored after splitting the first set.

9. The method of claim 1, wherein the merging the first subset and the second subset is performed by lazy evaluation.

10. The method of claim 1, wherein the query contains an anchor denoting a starting point for identifying a node in the second subset having a relationship to a node in the first subset.

11. The method of claim 1, wherein the one or more relationships is a shared node attribute having conflicting values in the first subset and the second subset, and a merge policy is utilized in determining a mechanism by which to merge the first subset and the second subset, the merge policy determined based on a schema by which data in the first subset and second subset is stored.

12. The method of claim 11, wherein the merge policy is selected from: a concatenation policy, a union policy, and an overwrite policy.

13. A system for merging a plurality of subsets split from a first set, comprising:
a memory for storing executable program code; and
a processor, functionally coupled to the memory, the processor being responsive to computer-executable instructions contained in the program code and operative to:
receive a query, the query specifying one or more relationships between a node in a first subset of the plurality of subsets and a node in a second subset of the plurality of subsets;
identifying, from the node in the first subset, an outgoing edge to the second subset, the outgoing edge corresponding to at least one of the one or more relationships common to the node in the first subset and the node in the second subset;
merging the first subset and the second subset; and
providing feedback related to the node in the second subset corresponding to the query.

14. The system of claim 13, wherein the first subset and the second subset each contain data that was contained in a single node in the first set.

15. The system of claim 13, wherein the one or more relationships between the node in the first subset and the node in the second subset relate to elements of tuples common to one another.

16. The system of claim 13, wherein a determination to split the first set is based on storage capabilities of a storage array on which the first set is stored and the size of the first set.

17. The system of claim 13, wherein the one or more relationships is a shared node attribute having conflicting values in the first subset and the second subset, and a merge policy is utilized in determining a mechanism by which to merge the first subset and the second subset.

18. A computer-readable storage device comprising executable instructions, that when executed by a processor, assist with merging a plurality of subsets split from a first set, the computer-readable medium including instructions executable by the processor for:
receiving a query, the query specifying one or more relationships between a node in a first subset of the plurality of subsets and a node in a second subset of the plurality of subsets;
identifying, from the node in the first subset, an outgoing edge to the second subset, the outgoing edge corresponding to at least one of the one or more relationships common to the node in the first subset and the node in the second subset;
merging the first subset and the second subset; and
providing feedback related to the node in the second subset corresponding to the query.

19. The computer-readable storage device of claim 18, wherein the first subset and the second subset each contain data that was contained in a single node in the first set.

20. The computer-readable storage device of claim 18, wherein a determination to split the first set is based on storage capabilities of a storage array on which the first set is stored and the size of the first set.
